(19) United States
(12) Patent Application Publication
(10) Pub. No.: US 2003/0099883 A1
(43) Pub. Date: May 29, 2003

(54) Lithium-ion battery with electrodes including single wall carbon nanotubes

(76) Inventors: Rosibel Ochoa, Lawrenceville, GA (US); Inna Kerzhner-Haller, Auburn, GA (US); Hossein Maleki, Lawrenceville, GA (US)

Correspondence Address: Motorola Energy Systems Group, Intellectual Property Department, 1700 Belle Meade Court, Lawrenceville, GA, 30043, US

(21) Appl. No.: 09/974,283

(22) Filed: Oct. 10, 2001

(51) Int. Cl. H01M 4/62; H01M 4/52

(52) U.S. Cl. 429/232; 429/231.1; 429/231.3; 429/223

(57) ABSTRACT

A lithium-ion battery that includes a plurality of electrodes, such as an anode and cathode, and at least one of the plurality of electrodes is made of a conductive material having a single wall Fullerene-carbon nanotube additive. The use of single wall carbon nanotubes as an additive in the electrode materials, even in very small amounts, improves the capacity, thermal stability, and safety of the electrode materials.

### TECHNICAL FIELD

The present invention generally relates to electricity producing batteries and their construction. More particularly, the present invention relates to lithium-ion batteries having single wall carbon nanotubes added to the electrode materials to improve the electrical capacity and thermal conductivity of the electrode materials in the batteries.

### BACKGROUND

Rechargeable Li-ion batteries are capable of providing both high voltage and excellent capacity, resulting in an extraordinary energy density. Lithium-ion batteries generally use lithium metal oxides as a positive electrode material, and various types of carbons as negative electrode materials. These electrode materials, due to their excellent ionic and electronic properties, generate an electrical flow from a chemical reaction. There is constant research to improve the electrochemical performance and thermal stability of Li-ion batteries through altering the composition of the electrodes.

It is known that the inclusion of carbon as an additive in the creation of electrodes, or as a coating of the electrodes enhances the electronic conductivity and capacity performance of Li-ion and other battery systems. Furthermore, it is know to use Fullerene-based carbon for its electrical and thermal conductivity. A type of Fullerene is a carbon “nanotube” which is made of single or multi-layered graphene sheets, rolled to form a cylinder. These forms of carbon come as multi-walls or nested tubes, single-wall and bundles of nearly parallel tubes. The nanotubes range in diameter that varies from 10-200 Å, depending if the tube is a single walled or a multi-walled system. Because nanotubes can be as long as one micron (1 μm), they are considered to be one-dimensional materials. Depending on the specific structural properties, single wall carbon nanotubes can act as either a metallic or a semi-conducting material. Moreover, carbon nanotubes exhibit high flexibility and tensile strength as well as high electrical conductivity (104-102 S/cm) and thermal conductivity (1800-6000 W/mK) and low surface area (1 m²/g).

Despite the remarkable properties of Fullerene carbon nanotubes, there are several issues that have hampered their commercialization. The main issue is the high cost and low yields from current synthesis methods of carbon nanotubes. A further issue is the lack of knowledge of the specific electrochemical behavior of carbon nanotubes in commercial applications.

It is known to use materials called carbon “nanofibers,” which are similar to carbon nanotubes, in lithium batteries. The nanofibers act as current collectors and as active anode materials for lithium-ion batteries. The fibers used in the invention are multi-walled, open-ended with diameters in the range of 3.5-75 nanometers. In such arrangement, the interconnected nanofibers act as current collectors in which the active cathode material is dispersed into the network. In the case of an anode, the fibers are the active material into which parallel graphene layers and lithium-ion are intercalated. This type of battery has only resulted in moderate improvement over standard lithium-ion batteries.

Accordingly, existing Li-ion and lithium-polymer batteries fail to utilize the extraordinary properties of Fullerene-carbon nanotubes to enhance the electrochemical performance of the battery. It is therefore to an improved lithium-ion battery that has single wall carbon nanotubes to enhance electrochemical performance that the present invention is primarily directed.

### BRIEF DESCRIPTION OF THE DRAWINGS

FIG. 1 is a cross-section of a lithium-ion battery in a coin-on-coin configuration.

### DETAILED DESCRIPTION OF THE INVENTION

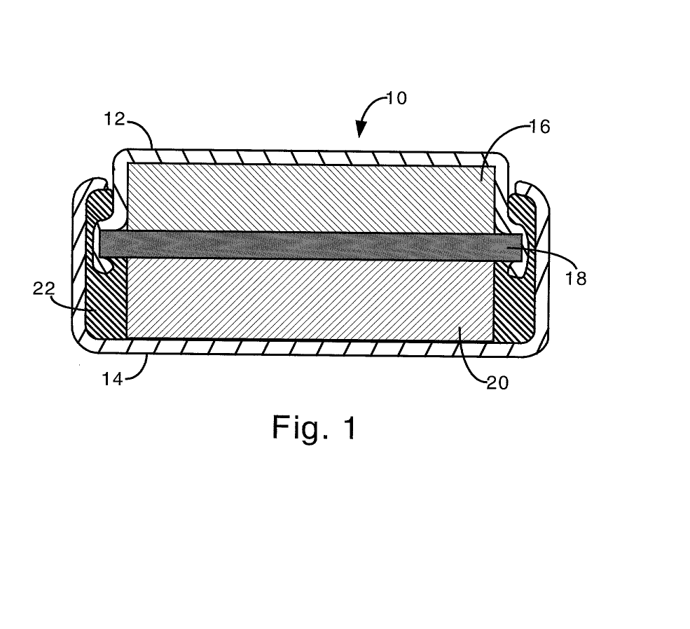

With reference to the drawings in which like numerals represent like elements throughout, FIG. 1 shows a coin-on-coin type lithium-ion battery 10 having an upper component 12 and a lower component 14, which are constructed of a conductive material. Within the upper component 12 is an anode 16, and within lower component 14 is a cathode 20, with separator 18 between anode 16 and cathode 20. The insulator 22 insures that the anode 16 is only in conductive connection with the upper component 12, and the cathode 20 is in conductive connection with the lower component 14 whereby conductive contact with both the upper component 12 and lower component 14 will close a circuit and allow voltage to flow due to the electrochemical reaction of the anode 16 and cathode 20. The coin-on-coin Li-ion battery configuration and other electrode and component configurations are well known in the art and the present inventive battery can be readily configured to any type of Li-ion or Li-polymer battery as would be apparent to one of skill in the art.

In the present invention, the application of single wall carbon nanotubes, as an additive to the electrode materials, or here added to the anode 16 and cathode 20, improves the capacity and thermal stability of the electrode materials used in Li-ion batteries. Experimental data indicate that the substitution of carbon black, a commonly used conductivity enhancer in Li-ion batteries, with a small amount of single wall Fullerene carbon nanotubes results in electrodes of higher active material utilization, i.e. higher electrode capacity. Experimental results also indicate a considerable increase in the reversible capacity of both a carbon fiber anode and a lithiated cobalt oxide cathode with additions only 0.5% by weight to the electrode composition. Due to the relatively meager amount of nanotube material employed for enhancement of the battery performance, the application of this invention is not hampered by the cost of the nanotube material.

Commercial carbon blacks consist of agglomerates of high surface area carbons of fine particles, which are commonly used as filler in battery electrode compositions (both anodes and cathodes). This enhances adhesion among the active materials and current collector of the electrodes. Conversely, the high surface area and difficulty of separating each particle from its agglomerate site, makes the carbon black a filler material that produces a porous electrode. High porosity tends to reduce thermal and electrical properties of electrodes. This effect is more dramatic on the metal oxides based cathode materials than over the carbon based anode materials used in Li-ion batteries. This effect is due to low thermo-electrical conductivity of common positive electrode materials of batteries, such as LiCoO₂, LiMnO₂ or LiNiO₂.

It is known that materials of high surface area or porosity tend to exhibit decreased heat conduction in composite systems such as electrodes, and as well as in single material systems such as graphite block. Furthermore, from a safety standpoint, porosity generates heat-traps that lower the heat transfer capability. Thus, the substitution of carbon nanotubes for carbon black can improve electrode thermal conductivity solely based upon the fact that nanotubes have higher thermal conductivity and produces electrodes of lower surface area than those electrodes using carbon black as filler.

The simple addition of carbon black to the electrode material increases the active surface area of the electrodes which results in an overall increase in its reaction with electrolytes. However, this reaction can be hampered by an irreversible capacity loss of the anode 16 and gradual oxidation and consumption of electrolyte on the cathode 20 that causes capacity decline during cycling and an increased threat to cell safety due to gas evolution and exothermic solvent oxidation.

In a liquid electrolyte or gelled polymer Li-ion battery system, generally, the electrode pores are filled with organic electrolyte that has high specific heat capacity (2 to 3 J/g-° C.) and low thermal conductivity (0.1 to 0.3 W/m-° C.). The organic electrolyte generally decreases thermal conductivity and increases the heat capacity of the Li-ion battery. The net effect of the organic electrolyte usage can be the increase of the onset of thermal “runaway” temperature of the Li-ion battery, and violent exothermic reactions can result once the battery's thermal runaway condition is reached.

Moreover, it is ill-advised to eliminate carbon black altogether. The total elimination of carbon black can lower the adhesion of electrode material as whole. Scanning electron micrographs show that the PVDF binder in the electrodes containing carbon black is distributed more uniformly than in the carbon fiber electrodes containing nanotubes. The high spread of PVDF generates good adhesion, but at the same time, can increase the Li/PVDF reaction site while Li-ion cell is under thermal runaway. The Li/PVDF reaction is highly exothermic and can be the difference between the battery having a mild or a violent thermal runaway.

Based on the higher thermo-electrical conductivity and lower surface area created by the use of the single wall carbon nanotubes, the nanotubes are a better filler-material choice than the high surface area carbon black agglomerates to minimize the risks associated with thermal runaway. However, perhaps combination of carbon nanotube and carbon black could supply electrodes of optimum thermo-electrical conductivity and low porosity.

TABLE 1

| | | | | Thermal |
|---|---|---|---|---|
| | | Surface Area | Resistance | Conductivity |
| Material | Density (g/cm) | (m²/g) | (Ω-cm) | (W/mK) |
| Carbon Fiber | 2.2 | — | 10⁻⁴ | 750 |
| LiCoO₂ | 5.01 | — | — | 1.9 |
| Nanotube | 1.40 | 1.0 | 10⁻⁴ | 1600-1800 |
| Carbon-black | 2.10 | 62 | 10⁻² | 1.59 |
| PVDF | 1.77 | — | 10¹⁴ | 0.17 |
| Graphite | 2.26 | 5.17 | 10⁻³ | 7.0-110 |

Table 1 displays the thermo-electrical properties and density of materials used in manufacturing the electrodes. The property-values for battery-grade graphite are included for comparison.

TABLE 2

| | | | | Thermal |
|---|---|---|---|---|
| | Density | Porosity | Resistance | Conductivity |
| Porous Graphite | (g/c²) | (v %) | (Ω-cm) | (W/mK) |
| Graphite Grade 60 | 1.05 | 52 | 3.04 × 10⁻³ | 85.5 |
| Graphite Grade 45 | 1.04 | 53 | 3.30 × 10⁻³ | 77.8 |
| Graphite Grade 25 | 1.03 | 53 | 3.81 × 10⁻³ | 69.2 |

Table 2 illustrates the effect of density and porosity upon thermo-electrical properties of graphite block. As one can see, increasing porosity or decreasing density lower the thermo-electrical values of materials. The same effect can be considered when adding the carbon black or nanotube to the electrode material. Increasing porosity to lower thermo-electrical conductivity is preferable due to the ease of manufacture.

In proving the benefits of adding single wall Fullerene-carbon nanotubes to the electrode material, a Li-ion battery was constructed with anode 16 and cathode 20 coated with different slurry formulations in which the amount of carbon black and single wall nanotubes was varied between 0.1 to 1%. The carbon nanotubes used are single-walled with a diameter preferably less than 2.0 nanometers.

The slurry for the negative electrode was made by first dispersing various amounts (3.1 or 18.2 mg) of single-wall nanotubes (provided by Carbolex) into 1.5 g of 1,methyl-2pyrrolidinone (NMP solvent). This dispersion was sonicated for 3-6 minutes and then added to 4.5 grams of a 5% solution of polyvinylidene fluoride (PVDF) binder dissolved in NMP. The resulting dispersion was then mixed with 3.5 g of carbon fiber anode provided by BP Amoco. Afterwards, the slurry was cast into a uniform film on 12 gm Cu-foil using a bench-scale coater. The coated films were dried at 110° C. and then calendered at 50 kgf/cm² of pressure.

Cathode Formation

A similar procedure was followed for coating of the positive electrode: different amounts of single wall carbon nanotubes were dispersed into 2.0 g of NMP, sonicated, and then added to 3.5 g of 5% solution of PVDF dissolved in NMP. The resulting dispersion was added to a mixture of 3 g of lithiated cobalt oxide and 0.132 g graphite KS-6. The slurry was cast into a uniform film on 10 A1 gm foil. The coated film was dried at 120° C. and calendered at 80 kgf/cm² to a density of 3.2 g/cm³.

Electrochemical performance was measured against lithium metal in coin cell configuration. Coin cells were assembled using disks 1.6 cm in diameter each weighing approximately 16 mg of active anode material (such as anode 16) and 15 mg of cathode active material (such as cathode 20). All cells were cycled between 2V and 0V versus metallic lithium at a rate of 0.2 mA.

Table 3 summarizes the conditions and active material content for the tests and the electrochemical improvement thereof:

TABLE 3

| | Conductivity | % of Conductivity | Reversible |
|---|---|---|---|
| Active Material | Enhancer | Enhancer | Capacity (mA/g) |
| BP Fiber | Nanotube | 0.085 | 264 |
| 14327-57 | | | |
| BP Fiber | Nanotube | 0.5 | 290 |
| 14327-57 | | | |
| BP Fiber | C-black | 1.0 | 272 |
| 14327-57 | super P | | |
| BP Fiber | C-black | 5.0 | 275 |
| 14327-57 | super P | | |
| Lco | Nanotube | 0.5 | 155 |
| Lco | C-black | 1.0 | 137 |
| | super P | | |

There is accordingly a considerable improvement that the addition of only 0.5% by weight of the single-wall nanotubes provides to the reversible capacity of the carbon fiber. The plain electrode material exhibits a value of 265 mA/g whereas the one containing 0.5% of nanotube additives exhibits an average capacity of 290 mA/g, a 9.4% improvement. To obtain a similar improvement in capacity it was necessary to add 5% by weight of carbon black, an order of magnitude higher. Even though the addition of 5% carbon black results in a similar effect to that observed with the nanotube addition, there is a loss in volumetric capacity due to the volume occupied by the additional carbon black additive. The single wall carbon nanotubes do not require a significant volume present to achieve the improved electrochemical performance.

A typical lithium ion cell contains approximately 12 g of active cathode material and can exhibit a cell capacity of 1656 mA. By substituting the regular cathode with an electrode containing 0.5% single wall carbon nanotubes as the conductivity enhancer instead of carbon black, the cell capacity can be as high as 1860 mA, an improvement of 12%.

Table 3 gives thermal conductivity values for anode and cathode materials, calculated using the following equation:

$$K = \frac{\sum {[ ( m / ρ ) K ]}_{i}}{\sum {( m / ρ )}_{i}}$$

Here, m, ρ, and K are mass in wt %, density (g/c³) and thermal conductivity (W/mK) of the components in the electrode materials.

TABLE 4

| | Carbon Fiber Anode | | | | Graphite Anode | | Cathode | |
|---|---|---|---|---|---|---|---|---|
| Parameters | #1 | #2 | #3 | #4 | #1 | #2 | #1 | #2 |
| LiCoO₂ | 0.00 | 0.00 | 0.00 | 0.00 | 0.00 | 0.00 | 91.5 | 91.0 |
| Graphite | 0.00 | 0.00 | 0.00 | 0.00 | 93.0 | 93.0 | 0.00 | 0.00 |
| Carbon | 93.0 | 94.2 | 93.0 | 89.0 | 0.00 | 0.00 | 0.00 | 0.00 |
| Fiber | | | | | | | | |
| PVDF | 6.00 | 6.00 | 6.00 | 6.00 | 6.00 | 6.00 | 3.90 | 4.00 |
| Nanotube | 0.50 | 0.089 | 0.00 | 0.00 | 0.50 | 0.00 | 0.50 | 0.00 |
| Carbon | 0.00 | 0.00 | 1.00 | 5.00 | 0.00 | 1.00 | 0.00 | 1.00 |
| Black | | | | | | | | |
| Carbon-Ks- | 0.00 | 0.00 | 0.00 | 0.00 | 0.00 | 0.00 | 4.15 | 4.00 |
| 6 | | | | | | | | |
| Electron | 9.35 | 8.50 | 9.03 | 9.55 | 9.35 | 9.03 | 4.27 | 19.4 |
| Mass | | | | | | | | |
| K-Values | 706 | 687 | 690 | 655 | 60.5 | 52.0 | 10.93 | 2.14 |
| (W/mK) | | | | | | | | |

Table 4 shows that the application of nanotubes or carbon black as an additive has small effects on thermal conductivity of carbon fiber anode material. Such small effect is because of the thermal conductivity of the carbon fiber being higher than PVDF and an application of small amount of carbon black or nanotubes additives. Nonetheless, an application of single wall nanotubes at 0.5 wt % rather than carbon black at 1.0 w % can increase the thermal conductivity of the cathode material by factor of 5.

Using the above formula, the thermal conductivity values were calculated as if the anode material were made of battery grade graphite (K-value=58.5 W/mK) and raw materials of mass ratios (wt %) given in Table 3, under “Graphite Anode”. For comparison, anode samples with 1.0 wt % carbon black (#1) and 0.5 wt % nanotube (#3) were selected.

As can be seen in Table 4, by changing from carbon fiber to graphite, the effect on thermal conductivity by using carbon black instead of single wall nanotubes as an additive becomes greater: note the difference between K-Values in column 1 and 3, under Carbon Fiber Anode versus K-Values in columns 1 and 2 under Graphite Anode. These results show that if a larger mass ratio of carbon black is used, the thermal conductivity difference between using nanotubes or carbon black will become larger.

While there has been shown a preferred lithium-ion battery with several alternative constructions, it is to be understood that further changes may be made to the elements used and arrangement of the components of the battery without departing from the underlying spirit and scope of the invention which is set forth in the claims.

What is claimed is:

1. A lithium-ion battery, comprising:
a plurality of electrodes; and
wherein at least one of the plurality of electrodes is comprised of a conductive material having a single wall carbon nanotube additive.

2. The battery of claim 1, wherein the plurality of electrodes is an anode and a cathode, and the anode and cathode are each comprised of a conductive material having a single wall carbon nanotube additive.

3. The battery of claim 1, wherein the conductive material comprising the electrode further comprises carbon.

4. The battery of claim 1, wherein the conductive material comprising the electrode further comprises a lithiated transition metal oxide.

5. The battery of claim 4, wherein the lithiated transition metal oxide is selected from the group consisting of lithiated cobalt oxide, lithiated nickel oxide and lithitiated nickel oxide with cobalt doping.

6. The battery of claim 1, wherein the conductive material comprising the electrode comprises graphite.

7. The battery of claim 1, wherein the single wall carbon nanotube additive is present in at most one percent of the electrode by weight.
